(19) United States
(12) Patent Application Publication
(10) Pub. No.: US 2010/0197359 A1
(43) Pub. Date: Aug. 5, 2010

(54) Automatic Detection of Wireless Phone

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/362,491

(22) Filed: Jan. 30, 2009

(51) Int. Cl. H04M 1/00

(52) U.S. Cl. 455/569.1; 455/569.2

(57) ABSTRACT

Cell phone in the area of the driver is detected. The detection of the cell phone in the area of the driver causes an action. The phone can be automatically paired with a Bluetooth capability in the vehicle. That pairing can be temporary. The vehicle can be made less pleasant to drive, e.g., by using a buzzer or limiting the speed of the vehicle.

### BACKGROUND

Certain laws and regulations govern acceptable use of cell phones in automobiles. For example, in certain states, it is not allowable to talk on a cell phone in an automobile while driving without a hands-free device.

However, these hands-free devices need to be paired with the cell phones before using. The pairing is necessary so that users do not interfere with others' talking on their cell phones with Bluetooth devices. People who enter an automobile do not just immediately start talking on someone else's hands-free device.

Bluetooth devices use a pairing technique where certain operations are carried out in order to pair the device with the associated paired device.

Pairing may be difficult and inconvenient. However, when driving an automobile, you may be forced to use a hands-free device.

### SUMMARY

The present application describes a technique of automatic pairing of wireless devices.

Another aspect describes an automatic pairing of devices, where the automatic pairing is selected by detecting a user's location.

### BRIEF DESCRIPTION OF THE DRAWINGS

FIG. 1 shows an interior of a car with Bluetooth parts; and

FIG. 2 shows a flowchart of operation.

### DETAILED DESCRIPTION

Pairing between a portable wireless device and a cell phone is conventionally a permanent pairing operation. In an embodiment, a device such as a Bluetooth headset may be paired with a cellular phone. Thereafter, each time that the user uses that phone near the Bluetooth device, the Bluetooth device is automatically coupled to the phone. Information about the pairing, for example, is saved within a registry, and used the next time the pairing is carried out.

However, the inventor recognized that there are special situations. For example, consider the situation of when you drive a rental car that has a built in hands free, e.g. Bluetooth speakerphone capability. A user might not want to pair permanently with that rental car, because a user is only going to be in the rental car for a short period of time, e.g. days or weeks. Similarly, if a user is driving in someone else's car, pairing may not be worth the trouble. Even if the user is willing to carry out the steps to pair, the user may feel like it is an intrusion to pair your cell phone with someone else's vehicle.

According to an embodiment, a pairing is carried out automatically or preferentially between a portable device, e.g., a hands free system, and a vehicle based system, e.g., a car-based hands free system such as Bluetooth, based on the location of the device and/or the user in the vehicle. According to one embodiment, however, when forced pairing is carried out, that forced pairing is a temporary pairing, rather than the permanent pairing which is usually done by such systems.

Another embodiment detects a position of a person speaking and initiates a special mode in the phone of the person in the driver's seat, in which the phone prevents certain operations (e.g., use against the user's ear rather than with a hands free handset) by the person in the driver's seat.

Another embodiment may wholly prevents use of a cell phone by a driver. This may be a selectable mode, for example, a parental override mode which prevents the driver from using their cell phone at all.

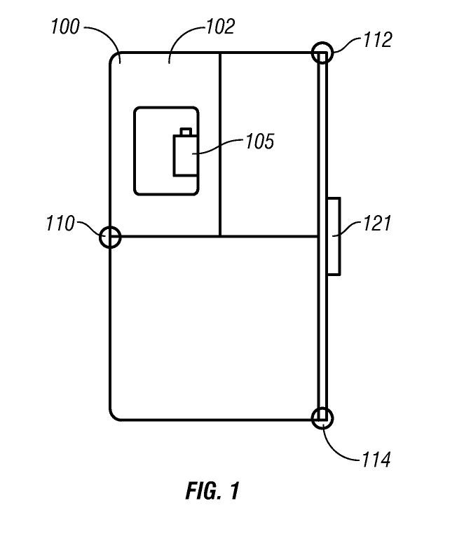

An embodiment is shown in FIG. 1. This embodiment describes use of a Bluetooth remote/hands free device in an automobile, however it should be understood that other forms of communication and other pairing can be carried out in a similar way. For example, the pairing may use an 802.11 WiFi system or infra red communications.

The automobile 100 has a first area shown generally as 102, in which the driver is located. In this embodiment, there may be a number of different Bluetooth receivers, shown generally as 110, 112. The location of the cell call or the person who is speaking can be determined. According to an embodiment, the Bluetooth receivers may be asymmetric relative to one another. Another Bluetooth receiver 114 may also be in a location to triangulate the location of the source for the Bluetooth communication. In an embodiment, each of the Bluetooth receivers is controlled by a controller 120, which may be the main controller of the vehicle, or may be a processor that is dedicated to only certain functions.

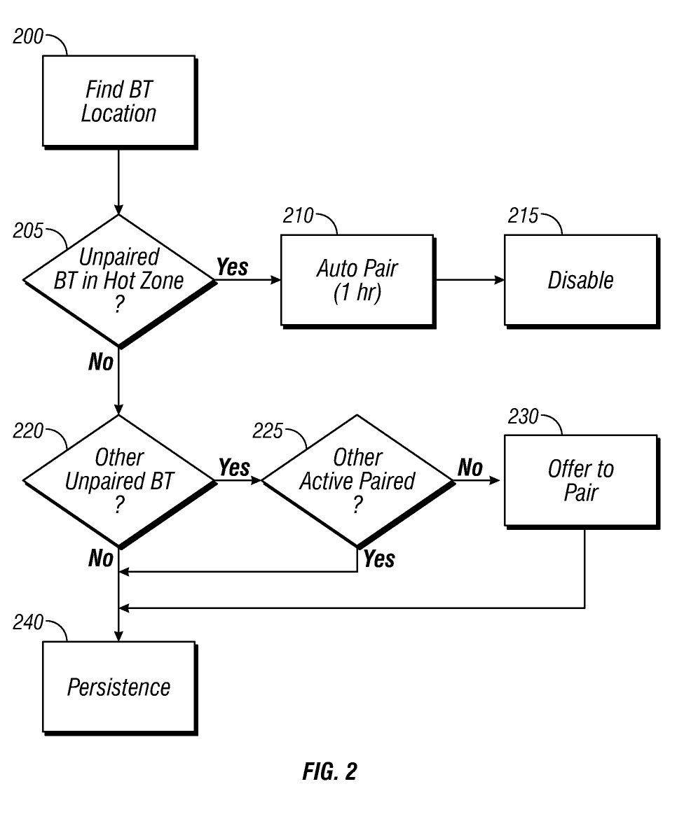

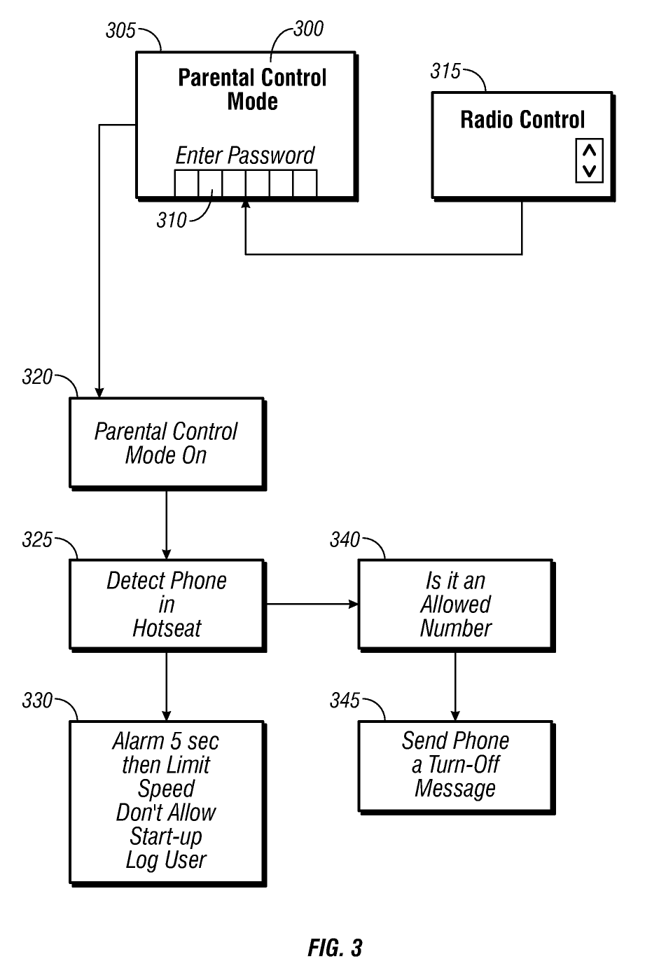

The controller 120 operates according to the flowchart of FIG. 2. At 200, the system finds the location of the Bluetooth devices. For example, in the embodiment of FIG. 1, there is a phone 105 in the location within the area 102. The location of the phone 105, or of any other phone within the passenger compartment, can be found by triangulating between the different Bluetooth receivers. As an alternative, the system can simply find which Bluetooth receiver receives the highest signal strength, and establish the phone as being nearest to that receiver that receives the highest signal strength. According to one embodiment, the controller 120 may pulse the different receivers on for different periods of time, for example first pulsing on the receiver 110, then the receiver 112, then the receiver 114.

Another embodiment may use IR detection to find the location of the phone, or may detect the audio of a person speaking to detect their location.

While the above has described one particular layout of Bluetooth receivers, it should be understood that the receivers can be located in an array, e.g., a linear array or two-dimensional array, or in any other formation.

At 205, the system determines whether there is an active and operating phone within the “hot zone” 102. Here the hot zone 102 is an area around the driver of the automobile. Certain states may require by law that phones within that area be operated by Bluetooth. The automobile may have Bluetooth functionality, e.g., a handsfree wireless speakerphone operation as part of the automobile. However, this operation conventionally requires pairing with the specific phone being used.

In an embodiment, if an unpaired phone is found in the hot zone, the system may automatically pair that phone with the handsfree unit in the automobile. The unit is paired at 210. That pairing may be “temporary”, e.g., for a fixed time period, for example one hour. During the operating time of the automatic pairing caused by finding a phone in the hot zone, the auto based system may disable all other previously paired Bluetooth phones in range. This forces a pairing of a Bluetooth phone in the hot zone with the Bluetooth hand-free capability of the automobile.

In an embodiment, the automatic pairing may be disabled, so that there is a first mode that causes automatic pairing of phones in the driver's seat, and another mode in which the phone in the driver's seat is not automatically paired. The mode(s) may be controlled using menus on the vehicle to determine settings.

One embodiment may detect if the phone in the hot zone is already paired with a handsfree device, e.g. the user's own device. This previous pairing may override the mandatory pairing in the hot zone.

If there is no unimpaired Bluetooth in the hot zone 102 at 205, then 220 determines if there is another unimpaired Bluetooth device in the vehicle. If so, 225 first determines if there is another active paired Bluetooth if so, then no action is taken, but if not then the system offers to pair at 230. The offer to pair at 230 can be an oral text to voice operation. The oral operation can read the name of the phone, and read, using automated text-to-voice “phone name, would you like to pair with the Bluetooth in this vehicle”? The user is given the opportunity, then, to pair at 230. A normal operation is carried out to find normal pairing, however, if more than one phone is found, the offer at 230 may be an offer to pair the closest phone to the driver, or may be an offer to pair both phones.

The automatic pairing carried out according to this flowchart may be temporary, and may only persist for a specified amount of time, e.g., 1 hour, 2 hours, 4 hours, 1 day, or 1 week. The term persistence is used herein to represent the fact that the pairing is only temporary. According to one embodiment, the pairing may persist only until a specified event, e.g., until the automobile is shut off, or until another driver with another phone is detected. According to another embodiment, the pairing persists until the pairing is not used for a specified amount of time, for example 24 or 48 hours.

The above embodiments disclosed detecting use of a cell phone in a specified area of the automobile, and carrying out at least one action that effects the use of the cell phone in the vehicle based on detecting that cell phone in that area. In the above embodiment, the action may include an automatic pairing of the cell phone with the Bluetooth capability of the vehicle if the cell phone does not already have a Bluetooth capability paired. In another embodiment described with reference to FIG. 3, that action which is detected when the cell phone in the area is detected is to warn and/or limit some operation of the vehicle.

The embodiment of FIG. 3 uses this as part of a “parental control mode” 300 which can be entered as part of the operation of the vehicle. The mode need not be a parental control mode, for example, it can just be any operating mode which restricts some vehicle operation or carries out some warning, when the phone is used in the driver's seat. The embodiment describes a parental control mode that may be entered as one mode that is selected on the vehicle dashboard 305. A password 310 may be required to change any aspect of the parental control mode. The password and the mode entry can be entered using keys that are on the radio, or for example other mode entry buttons such as on the steering wheel.

In operation, the controller 120 detects when the parental control mode is on at 320. This parental control mode prevents the driver from using the cell phone at all. 325 detects an active phone in the hot seat, that is, any phone being used for a call. This may be detected, for example, by detecting the Bluetooth signal in the hot seat, by detecting the RF signature of the cell phone, by detecting a person talking, or by any other means. 325 detects that the person sitting in the hot seat, presumably the driver, is using a cellular phone.

At 330, responsive to detecting the phone, the automobile carries out an operation to dissuade the user from continuing to use the phone. This may change a vehicle operation in a way that makes it less pleasant to drive the vehicle. One operation may emit a loud warning buzzer, e.g., similar to the buzzer that is played when the user does not have a seatbelt on. Another dissuading operation may be to limit the speed that the vehicle. For example, if the user is on a highway, it may be dangerous to immediately limit the speed of the vehicle, however the maximum speed of the vehicle may be slowly reduced, so that the travelling is eventually reduced to a speed where they have the choice of either turning off the phone, or having a significantly reduced speed.

Another operation may not prevent the user from moving the vehicle, once stopped, while on the phone.

The use of the cell phone may also be logged, and may be for example sent by text message or another message channel to the parents to indicate that the driver is in fact using the cell phone contrary to their demands.

Another embodiment operates when a specially configured phone is used in the vehicle. In this mode, when the phone is detected at 325, 340 detects if the phone is calling one of a plurality of different allowed numbers. For example, the parents may allow calling certain allowed numbers. These allowed numbers can be placed on the allowed list. These may include, the home number, school numbers, sibling numbers, 911, and the like. If the number being called is not an allowed number, then the phone is sent to turn off message at 345. This specially configured phone will automatically drop the call and prevent further calling when receiving such a turn off message. The turn off message may be sent wirelessly from the vehicle, for example it may be sent via Bluetooth or WiFi.

The embodiment of FIG. 3 allows the parental controls to be set within the vehicle menuing system. However, in an alternative embodiment, those parental controls can be set by menus on the phone rather than menus in the vehicle.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other devices can be controlled in this way, over other protocols including wifi, other network protocols, and others. The techniques can be used in other than vehicles, for example, in airplanes or houses or boats. The above has described taking certain actions when the phone is in the drivers seat, and it should be understood that other actions can alternatively be taken when the phone is in the drivers seat.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

The computers described herein may be any kind of computer, either general purpose, or some specific purpose computer such as a workstation. The computer may be a special purpose computer such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A system comprising:
a hands free operation device for a portable phone that carries out wireless communication with a portable phone; and
a phone detection part, that automatically detects a portable phone, and automatically causes pairing between said hands free operation device and said portable phone that is detected, said pairing causing communication over the portable phone to be carried out over said hands free operation device.

2. A system as in claim 1, wherein said hands free operation device is in a vehicle.

3. A system as in claim 2, wherein said phone detection part detects said phone in a specific area within said vehicle to automatically cause said pairing, and does not pair said phone and said hands free operation device unless said phone is in said specific area.

4. A system as in claim 3, wherein said phone detection part detects said phone within a driver's area of the vehicle to cause said pairing.

5. A system as in claim 1, wherein said pairing is a temporary pairing.

6. A system as in claim 5, wherein said pairing persists for only a fixed time.

7. A system as in claim 5, wherein said pairing continues only until a specific event occurs, and said pairing is terminated after said specific event.

8. A system as in claim 7, wherein said specific event is a shut off of the vehicle.

9. A system as in claim 7, wherein said specific event is a passage of a specific amount of time.

10. A vehicle system, comprising:
a vehicle system that detects use of a first cell phone in a specific area of the automobile, and carrying out at least one action in the vehicle based on detecting the first cell phone in said specific area, and not carrying out said at least one action when use of a cell phone is detected in areas of the vehicle other than in said specific area of the vehicle.

11. A system as in claim 10, wherein said action includes automatically pairing said cell phone with a hands free communication in said vehicle.

12. A system as in claim 11, wherein said pairing is temporary, and only lasts until a specified event.

13. A system as in claim 10, wherein said action includes changing a vehicle operation in a way that makes it less pleasant to drive the vehicle.

14. A system as in claim 13, wherein said action comprising emitting an audible warning.

15. A system as in claim 13, wherein said action comprising limiting a speed of the vehicle.

16. A system as in claim 13, wherein said action is controllable according to a parental control.

17. A method comprising
first operating a vehicle in a first mode where it detects cellular phone use in an area of a driver and where said vehicle automatically takes at least one action to automatically change an operation responsive to detecting said cellular phone use in said area of said driver, where said vehicle does not take said at least one action automatically when cellular phone use is detected in other areas, other than the area of said driver; and
second operating said vehicle in a second mode where cellular phone use in an area of a driver does not automatically take said at least one action.

18. A method as in claim 17, wherein said at least one action comprises automatically pairing said cell phone with a hands free communication device in said vehicle.

19. A method as in claim 18, wherein said pairing between said cell phone and said hands free communication device is temporary, and further comprising using said cell phone in said vehicle at a future time where said cell phone is not paired with said hands free communication device at said future time.

20. A method as in claim 17, wherein said at least one action includes changing a vehicle operation in a way that makes it less pleasant to drive the vehicle.

21. A method as in claim 20, wherein said action comprising emitting an audible warning.
